(19) United States
(12) Patent Application Publication
(10) Pub. No.: US 2008/0292195 A1
(43) Pub. Date: Nov. 27, 2008

(54) Data Processing System And Method

(76) Inventors: Deepu VIJAYASENAN, Martigny (CH); Praphul Chandra, Bangalore (IN); Anjaneyulu Seetha Rama Kuchibhotla, Bangalore (IN); Shekhar Ramachandra Borgaonkar, Bangalore (IN); Rahul Ajmera, Bangalore (IN); Prashanth Anant, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/109,381

(22) Filed: Apr. 25, 2008

(30) Foreign Application Priority Data
May 22, 2007 (IN) 1071/CHE/2007

(51) Int. Cl. G06K 9/62

(52) U.S. Cl. 382/224

(57) ABSTRACT

A method of organizing data, comprising receiving an image from an input device; recognising content in the image; and selecting, based on the content, a destination for at least one of the image and the content.

### RELATED APPLICATIONS

Benefit is claimed under 35 U.S.C. 119(a)-(d) to Foreign application Ser. 1071/CHE/2007 entitled “DATA PROCESSING SYSTEM AND METHOD” by Hewlett-Packard Development Company, L.P., filed on 22 May, 2007, which is herein incorporated in its entirety by reference for all purposes.

### BACKGROUND TO THE INVENTION

Input devices such as graphics tablets can be used to create an image by hand, where the image contains handwritten text and/or figures. A user uses a pen to draw or write on the input device, and the input device records the drawing and/or writing and forms an image therefrom. The user may write or draw onto, for example, a sheet of paper positioned on top of the input device, or may write or draw directly onto the input device. The image is provided to an input device application running on a data processing system. The input device application is associated with the input device and collects images from the input device. A user can then manually provide the images to another application, or extract content from the images and provide the content to another application.

It is an object of embodiments of the invention to at least mitigate one or more of the problems of the prior art.

### BRIEF DESCRIPTION OF THE DRAWINGS

Embodiments of the invention will now be described by way of example only, with reference to the accompanying drawings, in which:

FIG. 1 shows an example of a known system 100 for organising data;

FIG. 2 shows an example of a system for organising data according to embodiments of the invention;

FIG. 3 shows an example of an image provided by an input device;

FIG. 4 shows another example of an image provided by an input device;

FIG. 5 shows another example of an image provided by an input device; and

FIG. 6 shows another example of an image provided by an input device.

### DETAILED DESCRIPTION OF EMBODIMENTS OF THE INVENTION

Embodiments of the invention recognise content within an image, and select a destination for the image or the content. The image is received from an input device such as, for example, a graphics tablet and may comprise, for example, a vector and/or raster representation. The content may comprise, for example, text, gestures, shapes, symbols, colours and/or any other content, data and/or information within the image, and/or any combination of different types of content. Additionally or alternatively, the recognised content may comprise metadata associated with the image that may be found within or separately from the image. For example, the input device may include controls that may be used to specify information about the image, and the information may be metadata associated with the image.

The destination for the image (and/or any of the content therein, which may comprise the recognised content and/or any other content) may be, for example, one or more applications, or may alternatively be some other destination for the image and/or content.

A gesture may comprise a shape, symbol or some other content within the image. For example, the gesture may comprise a shape that is created using one or more strokes by the user. The number of strokes that were made to create a gesture may be included with or separately from the image, for example in a vector image or in metadata associated with the image.

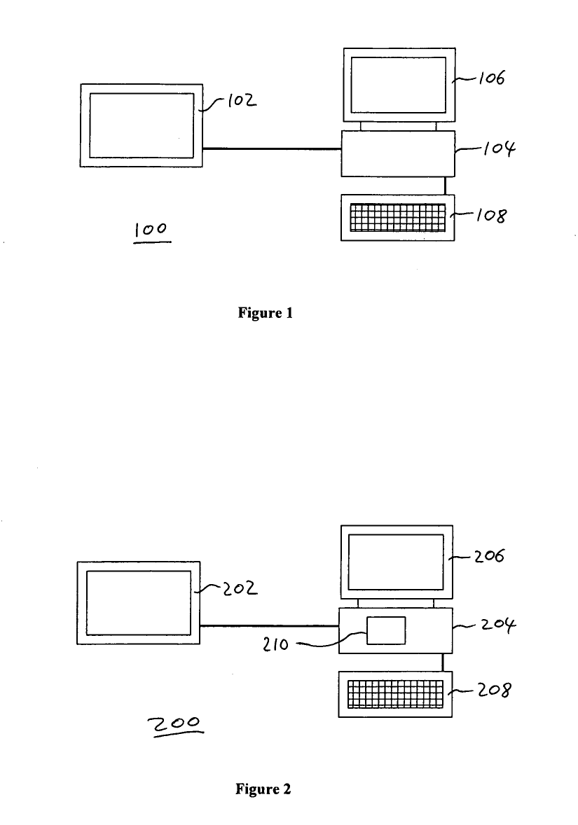

The system 100 of FIG. 1 comprises a graphics tablet 102 and a data processing system 104. A user (not shown) writes or draws on the graphics tablet using a pen or other tool (not shown). The tool may be specifically designed for use with the graphics tablet 102, or the tool may be a general purpose tool. The graphics tablet 102 may have one or more sheets of paper (not shown) placed on top of it for the user to write or draw on, or a user may write or draw directly onto the graphics tablet.

The graphics tablet 102 collects strokes (that is, lines, curves, shapes, handwriting and the like) made by the user. The graphics tablet 102 may provide information relating to the strokes to an input device application running on the data processing system 104 in real-time, as the strokes are made. Alternatively, the graphics tablet 102 may store the strokes without providing information to the data processing system 104. In this case, the graphics tablet 102 may include memory for storing the information, and can be used when not connected to the data processing system 104. The graphics tablet 102 can later be connected to the data processing system 104 to provide (download) all of the information stored to the data processing system 104. Multiple pages may be provided to the data processing system 104.

The information provided to the input device application running on the data processing system 104 may be, for example, one or more raster images (for example, bitmaps) of the page or pages written or drawn on by the user. Alternatively, the information may be in the form of vector graphics that describe the image or images. Alternatively, the vector graphics may be a list of the strokes made by the user which can be assembled into an image of the page or pages.

Once the information is provided to the input device application running on the data processing system 104 in the form of vector or raster images, the image or images are typically displayed on a display device 106 of the data processing system 104 by the input device application. The user then uses the input device application to manipulate the images, for example, to edit the images, copy and/or delete the images, and/or organise the images by providing the images and/or content therein to another application, such as, for example, a word processing application, email application or graphics application. The input device application may include means for extracting some content from the images such as, for example, optical character recognition (OCR) software. The user may use, for example, a user input device 108 (such as a mouse and/or keyboard) and/or the display device 106 to manipulate the images.

FIG. 2 shows a system 200 for organising data according to embodiments of the invention. The system 200 includes a graphics tablet 202, data processing system 204, display device 206 and/or user input device 208 (such as a mouse and/or keyboard) similar to those shown in FIG. 1. The system 200 also includes an organising application for organising data or information provided to the data processing system 204 by the graphics tablet 202.

When an image is provided to the data processing system 204 by the graphics tablet 202, the image is provided to the organising application 210. The organising application then recognises some content within the image, selects an application based on the recognised content, and sends the image and/or content in the image to the selected application. Therefore, the user does not need to manually interact with the organising application except when there is ambiguity or there are errors in the recognition, thus requiring fewer user skills and accelerating the organising process when compared to known systems.

The organising application selects an appropriate destination application for the image based on recognised content. The organising application first extracts at least some of the content from the image using, for example, optical character recognition (OCR) or handwriting recognition. The organising application 210 examines the content to attempt to recognise some of the content. If the organising application recognises some of the content, it uses the recognised content to select a destination application for the image and/or the content.

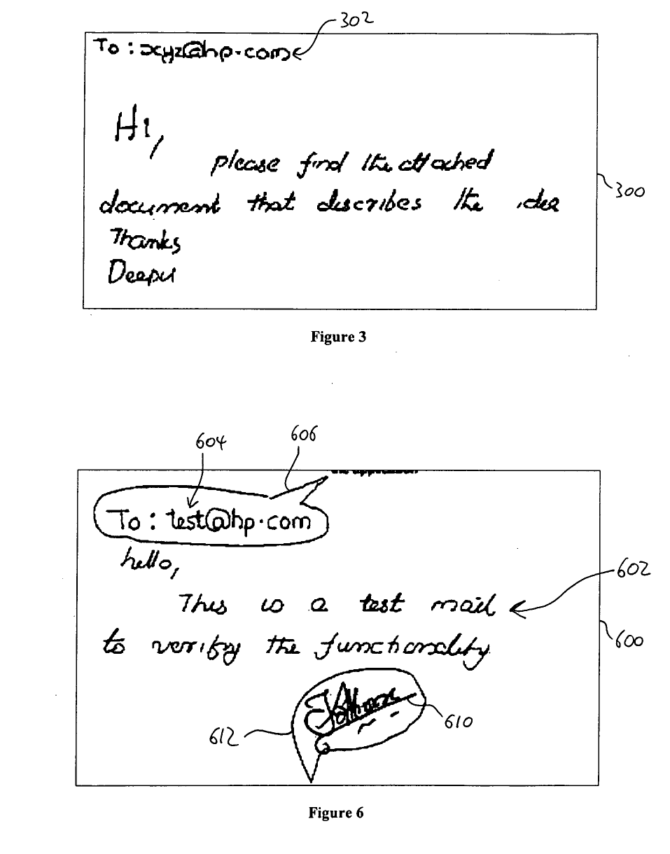

FIG. 3 shows an example of an image 300 that is sent by the graphics tablet 202 to the organising application 210. The organising application extracts and recognises the content 302, which reads “To: xyz@hp.com”, as being a destination email address for the content within the image 300. The image may have the content extracted from the image using, for example, optical character recognition (OCR) or handwriting recognition. Some or all of the content may be extracted from the image before the organising application 210 examines the content to attempt to recognise some of the content.

The organising application 210 may recognise various types of content and select an appropriate application accordingly. For example, where a postal address is recognised (which are typically in the top-right hand corner of a page and conform to a format, and are thus recognisable), the content of the image may be sent to a word processing application as the content is a letter, for example for posting or emailing as an attachment.

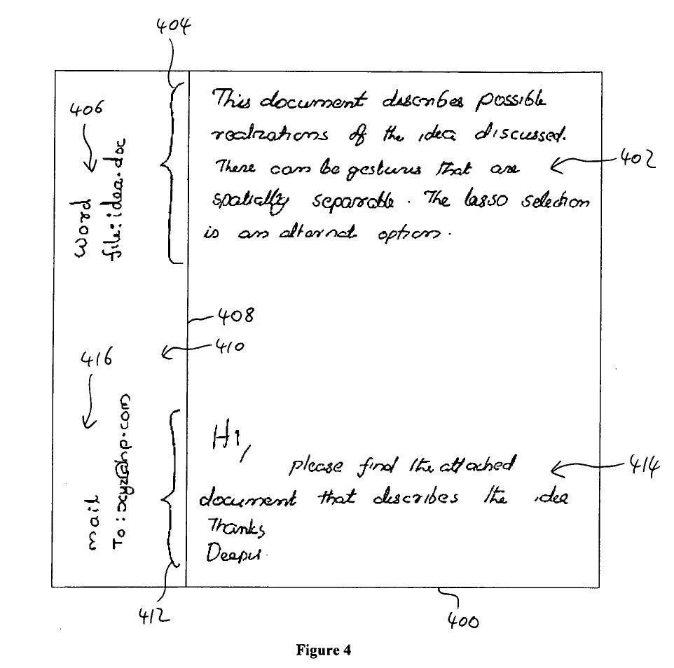

FIG. 4 shows another example of an image 400 sent to the organising application 210. The image includes a first area 402 of handwritten text that is selected or highlighted using a gesture 404 shaped as a left brace “{”. Metadata 406 is written alongside the gesture 404. The gesture 404 and the metadata 406 are located to the left of a margin 408 within a region 410. The margin 408 may, in certain embodiments, be imaginary and may not be visible within the image 400. In certain embodiments, the margin is present on paper placed over the graphics tablet 202.

The organising application 210 recognises the gesture 404 within the region 410 using, for example, known gesture recognition technology. Examples of gesture recognition technology that may be used may include one or more of the following, which are incorporated herein by reference for all purposes: “Handwritten Gesture Recognition for Gesture Keyboard”, R. Balaji, V. Deepu, Sriganesh Madhvanath and Jayasree Prabhakaran, Proceedings of the 10th International Workshop on Frontiers in Handwriting Recognition (IWFHR-10), La Baule, France, October 2006; “Scribble Matching”, Hull R., Reynolds D. & Gupta D., Proceedings of the 4th International Workshop on Frontiers in Handwriting Recognition, (1994), 285-295; “Automatic signature verification and writer identification—the state of the art”, Plamondon R., Lorette G., Pattern Recognition. Vol. 22, no. 2, pp. 107-131. 1989; “Character segmentation techniques for handwritten text—a survey, Dunn C. E., Wang P. S. P., Pattern Recognition, 1992. Vol. II., 11th IAPR International Conference on Pattern Recognition Methodology and Systems, Proceedings., pp 577-580.

The organising application 210 recognises the gesture 404 and determines that the area of text 402 is selected. For example, the area of text selected is the area substantially between the upper and lower bounds of the gesture 404 and across the full width of the page to the right of the margin 408. The organising application also extracts the metadata 406 content which reads “Word file:idea.doc”. The organising application determines that the text should be sent to a word processing application due to the presence of “word”, and also that the filename for the text 402 should be “idea.doc”. The organising application may send some or all of the image 400 to the word processing application, or may additionally or alternatively extract the text content from the area of handwritten text 402 and send the extracted content to the word processing application. In embodiments of the invention, the user may interact with the organising application to define keywords such as, for example, “word” and/or other keywords, and to define the application associated with the keywords.

Similarly, the organising application 210 recognises a second gesture 412 within the region 410, and recognises that an area of handwritten text 414 is selected. The organising application 210 extracts metadata 416 content adjacent to the gesture 412, and recognises that it comprises “Mail to:xyz@hp.com”. The organising application 210 recognises the presence of “Mail” and selects a mail (for example, email) application. The organising application also sends some or all of the image 400 to the mail application, or may additionally or alternatively extract the text content from the area of handwritten text 414 and send the extracted content to the mail application.

In certain embodiments, the gestures may be anywhere within the image 400 and may not necessarily be located within the region 410. In certain embodiments, there is no such region 410.

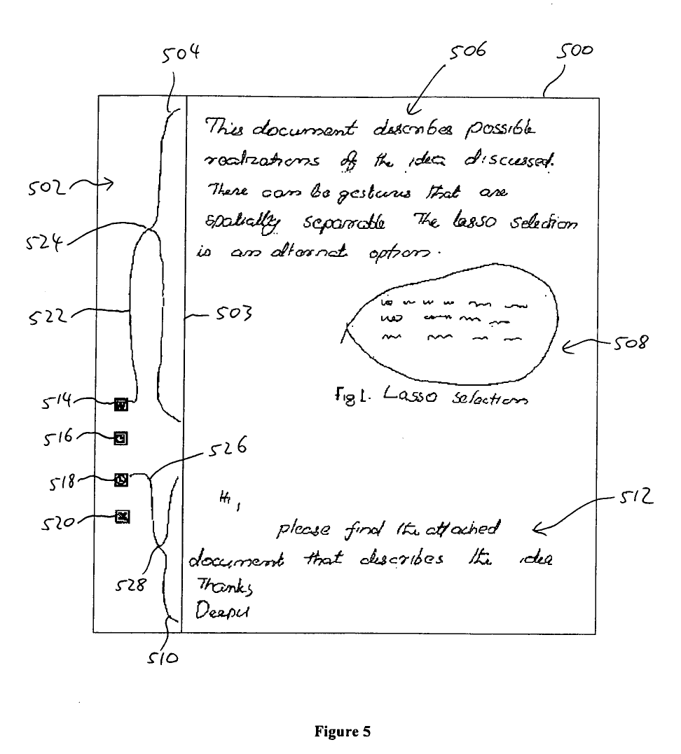

FIG. 5 shows another example of an image 500. The image 500 includes a region 502 to the left of the margin 503 (which may or may not be visible) where gestures may be present. The image 500 also includes a first gesture 504 within the region 502, which selects an area of text 506 and a FIG. 508, and a second gesture 510 that selects an area of text 512.

The image 500 also includes four icons 514, 516, 518 and 520 respectively. The icons may or may not be present within the image 500. The icons may, however, be present on, for example, a sheet of paper placed above the graphics tablet 202. The icons may act as substitutes for writing keywords or commands.

Each of the gestures 504 and 510 is associated with a curve that runs from the gesture to one of the icons 514, 516, 518 and 520. For example, the gesture 504 is associated with a curve 522 that runs from approximately the mid-point 524 of the gesture 522 to the icon 514. Similarly, the gesture 510 is associated with a curve 526 that runs from approximately the mid-point 528 of the gesture 510 to the icon 518. The curves may or may not touch the associated gesture or icon. Therefore, each gesture can be associated with an icon. The organising application 210 recognises which icon is associated with a gesture and uses this recognition to select an application. For example, the organising application 210 sends the area of the image 500 or the associated content, being the area of handwritten text 506 and the FIG. 508, to an application associated with the icon 514, as this icon is associated with the gesture 504 that selected the area of the image or the content. For example, the icon 514 may be associated with a word processing application, and therefore the organising application 210 sends the area of the image or the extracted content to the word processing application.

Similarly, if, for example, the icon 518 is associated with an email application, at least the area of handwritten text 512 or content extracted therefrom is sent by the organising application 210 to the email application.

FIG. 6 shows a further example of an image 600. The image 600 includes an area of handwritten text 602 and a destination email address 604 written as “To: text@hp.com”. The address 604 is surrounded by a gesture 606 shaped as a speech bubble. In embodiments of the invention, the organising application 210 does not consider a particular region for containing gestures, and does not recognise terms and phrases within content within the image. Instead, gestures are used to select portions of the content and the gesture indicates the nature of the content. For example, the organising application recognises that the gesture 606 surrounds text and the shape of the gesture 606 suggests that the text is a destination address. The organising application 210 therefore knows the type of data selected by the gesture 606. The organising application 210 determines that the destination is an email address, and thus provides the image and/or the content therein to the email application.

The image 600 includes a signature 610 that is surrounded by another gesture 612. The gesture 612 is also shaped like a speech bubble, although it is upside-down compared to the gesture 606. The shape (and orientation) of the gesture may be used by the organising application 210 to determine that the gesture 612 surrounds a signature 610. Therefore, for example, the signature 610 may not be converted into text and may remain as, for example, an image. Additionally or alternatively, the presence of a signature may be used by the organising application to determine, for example, that an electronic communication such as an email that contains content from within the image 600 should be digitally signed.

Thus, in embodiments of the invention as described above, the user does not need to interact with an application to organise data provided using a graphics tablet or other input device unless there are ambiguities or there errors in the recognition. Indeed, it is possible that the data provided may be completely processed by a data processing system (for example, processing an email means sending the email to the destination email address without the user ever needing to interact with a data processing system). For example, the user could compose and send emails merely by writing on the graphics tablet or other input device.

Embodiments of the invention are described above with reference to a graphics tablet being the input device. However, other input devices may be used instead, such as, for example, motion sensing tools, touch-sensitive displays and other input devices. Furthermore, alternative embodiments of the invention may integrate certain elements. For example, a PDA may incorporate both an input device (such as a graphics tablet or touch-sensitive display) with a data processing system.

In embodiments of the invention which recognise only text within the content of an image, then optical character recognition (OCR), handwriting recognition and/or other text recognition may be sufficient to select an application for the image and/or content. Thus, methods for recognising symbols, drawings, gestures and/or other non-text content may be ignored when recognising content within the image.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A method of organizing data, comprising:
receiving an image from an input device;
recognising content in the image; and
selecting, based on the content, a destination for at least one of the image and the content.

2. A method as claimed in claim 1, wherein selecting a destination comprises providing at least one of the image and the content to the application.

3. A method as claimed in claim 2, wherein recognising the content comprises recognising text in the image.

4. A method as claimed in claim 3, wherein selecting a destination comprises recognising at least one keyword in the text that is associated with a destination.

5. A method as claimed in claim 1, wherein recognising the content comprises recognising at least one gesture in the image.

6. A method as claimed in claim 5, wherein recognising the at least one gesture comprises recognising the at least one gesture in a predefined portion of the image.

7. A method as claimed in claim 1, wherein recognising the content comprises recognising the content in a predefined portion of the image.

8. A method as claimed in claim 1, wherein the input device comprises a graphics tablet.

9. A method as claimed in claim 1, comprising sending at least one of the content and the image to the selected application.

10. A method of selecting an application for images containing content, comprising receiving images from an input device, recognising content in the image, and selecting an application for at least one of the images and the content based on the recognising.

11. A system for organizing data, arranged to:
receive an image from an input device;
recognise content in the image; and
select, based on the content, a destination for at least one of the image and the content.

12. A system as claimed in claim 11, arranged to provide at least one of the image and the content to the application when selecting a destination.

13. A system as claimed in claim 12, arranged to recognise text in the image when recognising the content.

14. A system as claimed in claim 13, arranged to recognise at least one keyword in the text that is associated with a destination when selecting a destination.

15. A system as claimed in claim 11, arranged to recognise at least one gesture in the image when recognising the content.

16. A system as claimed in claim 11, arranged to recognise the content in a predefined portion of the image.

17. A system as claimed in claim 11, wherein the input device comprises a graphics tablet.

18. A method of composing an image, comprising creating content within the image using at least one of writing and drawing, and providing metadata within the image that indicates at least one of a type of the content and a destination application for at least one of the image and the content.

19. A computer program for implementing one of the method as claimed in claim 1 and the system as claimed in claim 11.

20. Computer readable storage storing the computer program as claimed in 19.
